(19) United States
(12) Patent Application Publication
(10) Pub. No.: US 2005/0269384 A1
(43) Pub. Date: Dec. 8, 2005

(54) Method of preventing flashing between solder pads on circuit board

(75) Inventors: Spring Liu, Taipei (TW); Ticky Tsai, Taipei (TW)

Correspondence Address: Mr. Peter F. Corless;EDWARDS & ANGELL, LLP, 101 Federal Street, Boston, MA, 02110, US

(73) Assignee: Inventec Corporation

(21) Appl. No.: 10/861,871

(22) Filed: Jun. 4, 2004

(51) Int. Cl. B23K 31/00

(52) U.S. Cl. 228/125

(57) ABSTRACT

A method of preventing flash between solder pads on a circuit board is proposed. The method involves the step of forming a solder resistant structure on a area between at least two solder pads on the circuit board, such that the solder masks isolates the solder material that flashes between the solder pads, so as to prevent the solder material from flashing adjacent solder pads, thereby eliminating the occurrence of short circuiting.

### BACKGROUND OF THE INVENTION

1. Field of the Invention

The present invention relates a method of preventing flash, and more particularly, to a method of preventing flash between the solder pads of an electrical component to connect with the solder pads without short-circuiting.

2. Description of the Related Art

In a generation where information is spreading at an explosive rate, consumers are led to move towards the top of the technological fashion trend. The dynamic change and breakthrough of the telecommunication products have brought up markets for consumer-type electronic products each year, such as personal computer (PC), personal telecommunication system, digital electronic communication product and the like. Therefore, it is more important for manufacturers of the electronic products to integrate different electronic parts on the circuit board. Since the current portable informative electronic product and mobile communications product are developed to be more compact, multi-functional, highly reliable, and less costly, the circuit design for the electronic product also needs to take into account an integration concept.

While the electronic components are tightly formed on the circuit board to fulfill the integration requirements, the solder pads corresponding to the terminals of the electronic product are closely arranged on the circuit board by such a design. As the electronic component is soldered to the circuit board, the solder material that flashes between the solder pads often connects to each other due to close distance between the solder pads of the electronic component, resulting occurrence of short circuit problem.

Conventionally, two Taiwan patents with publication numbers 469678 and 469679 were proposed to solve the short circuit problem caused by solder flash. The patent of publication number 469678 discloses modification of a fastening end in the terminals of the electronic product to connect to the circuit board, while an insulating housing formed with an accommodating channel to which the terminals penetrate and secure is disclosed in the patent with publication number 469679.

However, the above disclosure requires either modification of the electronic component or the addition of other devices, which increases process complexity and fabrication costs. Also, the terminals as described in the above patents are mounted by conventional Surface Mount Technology (SMI) on the circuit board. There is no disclosure of checking any defects between the electronic component and the circuit board after the reflow-soldering process. As the connection between the electronic component and the circuit board is not checked in time to determine if the connection is defective, the product yield is inevitably decreased.

Furthermore, a Taiwan patent of publication number 371369 provided a method for checking a connection of the connecting part in the IC socket pin of IC package and patterns on the printed circuit board. The method involves modifying alignment of the solder in the through hole of the IC socket pin for the IC package to check if there is defective soldering or short circuit problem. Although the IC package is free from heat-related defect via the IC socket after the reflow-soldering process as disclosed in the Taiwan patent of publication number 371369, it is more laborious and error-prone to conduct a visual inspection by such method, making it less economical.

Moreover, Applicant further proposed a method of improving the automatic optic test system from misjudging missing part and short circuit on Jul. 30, 2002. After the reflow-soldering process, the automatic optic test machine (or automatic optic test system) automatically checks on problems, such as missing piece, reversed plugging, wrong piece, open circuit, polarity, shading, shifting, floating pin, excessive solder, inadequate solder, slanting, flipping piece, white out, empty soldering, and cold soldering, so as to improve from drawbacks associated with visual inspection and misjudgment of the automatic optic test machine on the missing piece and short circuit.

The method of improving the automatic optic test system from misjudging missing part and short circuit allows checking of the defective connection between the electrical component and the circuit board after the reflow-soldering process based on the pattern that labels the electrical component on the circuit board. However, the aforementioned technology is applicable to the back end of SMT production line. In other words, instead of preventing the solder flashing problem beforehand, the manufacturer is only informed after the solder flashing occurs to respond accordingly by the aforementioned technology. And cleaning or rework processes are required after the test as described in other above-mentioned patents resulting more time and cost being spent.

Since the conventional method requires modification of the electrical component and addition of other devices and does not allow checking of the defective connection between the electrical component and the circuit board after the reflow-soldering process. The manufacturer is not informed in time to respond with any related processing after the solder flash occurs. As a result, the process complexity and cost are increased and the product yield is reduced. So, requirements for manufacture and related tests are not fulfilled by the conventional method, and problems associated with the conventional method still await further improvements.

### SUMMARY OF THE INVENTION

In light of the above-mentioned drawbacks associated with the prior art, the primary objective of the present invention is to provide a method of preventing flash between the solder pads on the circuit board.

Another objective of the present invention is to provide a method of preventing flash between the solder pads on the circuit board, such that each electrical component is checked for any defective connection with the circuit board even after the reflow process, so as to fulfill requirements for both fabrication and related tests.

And yet another objective of the present invention is to provide a method of preventing flash between the solder pads on the circuit board, so that the solder flashing is prevented without modifying structure of the electrical component and adding other elements.

And still another objective of the present invention is to provide a method of preventing flash between the solder pads on the circuit board, so that the fabrication process is simplified and cost effective.

A further objective of the present invention is to provide a method of preventing flash between the solder pads on the circuit board, applicable to component deficiency test, short circuit test, and other subsequent tests, in order to improve product yield.

In accordance with the above and other objectives, the present invention proposes a method of preventing flash between the solder pads on the circuit board. The method comprises the step of: forming a solder resistant structure on an area between at least two adjacent solder pads on the circuit board such that the solder resistant structure isolates flash of the solder material applied on one of the at least two adjacent solder pads from flash of the solder material applied on the other one of the at least two adjacent solder pads so as to prevent solder flash between the at least two adjacent solder pads. The solder pads provide soldering of the electrical component to the circuit board, wherein the electrical component may be a resistor, a capacitor, an inductor, a tantalum capacitor, an electrolyzed capacitor or a round electrolyzed capacitor, transistor or a 3-pin diode, an arrayed resistor, an arrayed capacitor, an integrated circuit (IC), a connector or a resonance transistor, a 6-pin transistor, a 6-pin IC or a 6-pin diode, and a semiconductor chip or IC packaged by ball grid array (BGA) technology.

The solder resistant structure is optionally formed to cover a substantial area between the solder pads or formed as a block at the area between the solder pads, while the solder resistant structure is optionally made higher or level with the solder pads. The solder resistant structure may also be made lower than the solder pads. Moreover, the solder resistant structure may be a solid or hollow square, while the solder resistant structure may optionally be formed with at least an isolating portion and/or at least a buffering portion to improve solder masking function.

Accordingly, the solder flashing is prevented using the solder resistant structure to resolve conventional problems where the defective connection between the electrical component and the circuit board is checked only after the reflow-soldering process, the manufacturer is not informed in time after the solder flash occurs to respond with any related processing, and the process complexity and cost are increased while the product is yield is reduced.

The design of the solder resistant structure in the present invention may be incorporated in designing the circuit board without any manufacturing difficulty. And there is no need to modify the electrical component or add other devices to increase the process complexity and manufacture cost as required in the conventional method

In addition, the solder resistant structure formed in the present invention also serves to label a pattern of the solder pads, so that the solder resistant structure allows an automatic optic testing machine (or automatic optic testing system) (not shown) to check for any defects such as missing part and short circuit after the reflow-soldering process. In other words, the connection between each of the electrical components and the circuit board is checked for any defects after the reflow-soldering process, so as to improve product yield, thereby avoiding failures of meeting requirements for manufacture and related tests in the conventional method.

### BRIEF DESCRIPTION OF THE DRAWINGS

The drawings included herein provide a further understanding of the invention. A brief description of the drawings is as follows:

FIG. 1 is an elevation view illustrating a method of forming a solder resistant structure between solder pads according to one preferred embodiment of the present invention;

FIGS. 2A through to 2F are elevation views illustrating other solder resistant structures;

FIG. 3 is an elevation view of FIG. 1; and

FIGS. 4A through to 4F are cross-sectional views illustrating a method of forming the solder resistant structure between the solder pads according to other embodiments of the present invention.

### DETAILED DESCRIPTION OF THE PREFERRED EMBODIMENT

The present invention is described below with reference to the following embodiments in a manner that one skilled in the art would easily understand from the disclosure of the invention other advantages and benefits of the invention. The present invention may also be embodied by other examples and modified without departing from the objective of the invention.

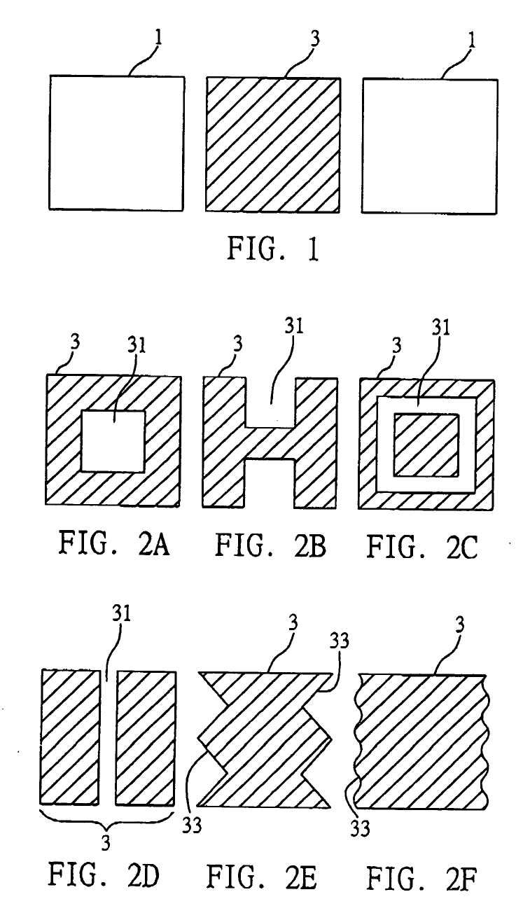

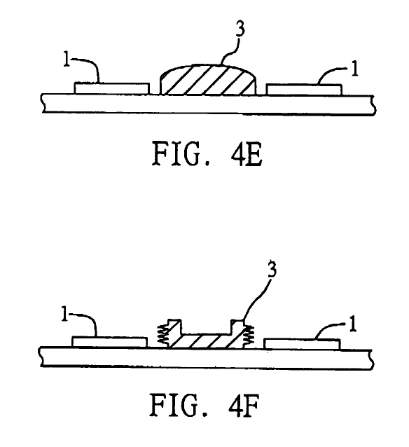

The preferred embodiments are described with reference to FIG. 1 and FIG. 4F below. The present invention proposes a method of preventing flashing between solder pads 1, wherein each of the solder pads 1 provides soldering of an electrical component to a circuit board (not shown). As shown in FIG. 1, the method involves forming a solder resistant structure 3 at an area of the circuit board between at least two solder pads 1.

The diagrams provided herein are simplified by illustrating only solder pads 1 corresponding to terminals for each of the electrical components on the circuit board (paper surface) as well as the solder resistant structure 3 that prevents solder material (not shown) between the solder pads 1 from flashing to the adjacent solder pad 1, while the electrical components are omitted. The electrical component may be a component having two terminals, such as a resistor, a capacitor, an inductor, a tantalum capacitor, an electrolyzed capacitor, or a round electrolyzed capacitor; a component having three terminals, such as a transistor or a 3-pin diode; a component having approximately two rows of terminals, such as an arrayed resistor, an arrayed capacitor, an integrated circuit (IC), a connector or a resonance transistor; a component having five terminals, such as a 6-pin transistor, a 6-pin IC or a 6-pin diode; and a semiconductor chip or IC packaged by ball grid array (BGA) technology. Since the above-mentioned electrical components and other constituents and functions thereof are well known by one skilled in the art, they are not further described herein.

The present embodiment is described with the electrical component having two terminals as an example for better illustration of the present invention. However, it should be noted that the invention is not limited as such, since the invention is also applicable to the electrical component having other numbers of the terminals.

The solder resistant structures illustrated in FIG. 1 includes one that covers a substantial area between two solder pads 1. As shown in the diagram, the solder resistant structure 3 is formed between the solder pads 1 and is represented in the form of a solid square, such that a suitable isolation area is formed via the solder resistant structure 3 from the area between the solder pads 1. As a result, the solder material that flashes between the solder pads 1 during fabrication process is isolated by the solder resistant structure 3 to prevent problems associated with flashing in the prior art.

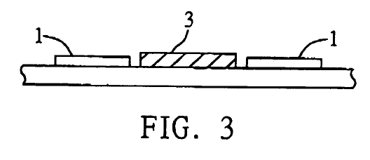

In other embodiments, the solder resistant structures may also be in the shape of “□”, “H”, “ [symbol] ”, “FIGS. 2A through to 2D. Also, the solder resistant structure 3 may optionally be formed with at least an isolating portion 31 as shown in the diagram. That is, the solder resistant structure 3 is not limited to a solder square structure, other hollow polygons such as trapezoid, hexagon, are also encompassed in the scope of the invention.

Therefore, the solder material that flashes between the solder pads 1 is not only blocked by the solder resistant structure 3, but also contained in the isolating portion 31 when the flashing gets worse, so as to achieve blocking in the area between the solder pads 1.

As illustrated in FIGS. 2E and 2F, at least one side of the solder resistant structure may optionally be formed as a jigsaw structure and a wavelike structure in a manner shown by a buffer portion 33. So while the solder resistant structure 3 blocks the solder flashing, the buffer portion 33 provides buffering effect in terms of reducing force of the solder flashing. The solder resistant structure 3 may optionally be formed with a plurality of isolating portions 31 or buffering portions 33 and not limited as illustrated when the solder resistant structure 3 is applicable to the electrical component having more than two terminals.

Meanwhile, the solder resistant structures formed with the isolating portion 31 and the buffering portion 33 should be made with less material than the solder resistant structure 3 not formed with the isolating portion 31 and the buffering portion 33 so as to reduce the cost.

Moreover, the design of the solder resistant structures may be incorporated in designing the circuit board to prevent not only the solder material that flashes, but also serve as an identification structure for an automatic optic testing machine (or automatic optic testing system) (not shown) to check whether connection between each of the electrical components and the circuit board is defective. This fulfills both requirements for manufacture and other related tests. Since technology and theory involved in checking connection between each of the electrical components and the circuit board using the automatic optic testing machine is well known by one skilled in the art, the details thereof are not further described herein.

Also, the solder resistant structure 3 is preferably made of non-conductive material so as to avoid serving as a bridge for connecting the solder pads 1 when the solder resistant structure 3 is used to block solder flashing. The solder resistant structure 3 is optionally made of white paint or other materials capable of being tested by the automatic optic testing machine or automatic optic testing system, but the material should not be limited as such.

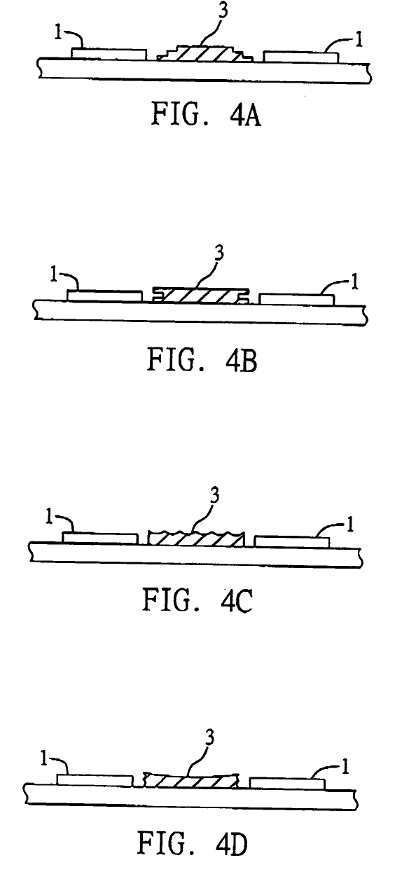

FIG. 3 is an elevation view of FIG. 1. As shown in FIG. 3, the solder resistant structure 3 is higher than the solder masks 1, so that the solder material that flashes between the solder pads 1 does not overflow the solder resistant structure to connect the solder pads 1. The solder resistant structures may certainly be made level with the solder pads 1. In other words, the preferred solder resistant structure 3 is higher or level with the solder pads 1.

For example, the solder resistant structure 3 may be one that is partially higher than the solder pads 1 or the structure that has stepwise or other irregular shapes as illustrated in FIG. 4A through to 4F. The top and sides of the solder resistant structure 3 may optionally be made of different shapes.

The height change and other changes illustrated in FIGS. 4A through to 4F may be combined with the modifications illustrated in FIGS. 2E and 2F to form a variety of solder masks 3 having solder masking function, and the solder masks 3 may also be used for testing missing part, short circuit, and other problems. Therefore, with the present invention, the solder flashing problem is prevented beforehand, and the connection for each of the electrical component to the circuit board may be checked for any defects even after the reflow soldering process.

As is understood from the embodiments, as the electrical component such as the resistor, capacitor, inductor, tantalum capacitor, electrolyzed capacitor or round electrolyzed capacitor, the transistor or 3-pin diode, the arrayed resistor, arrayed capacitor, IC, connector or resonance transistor, and the 6-pin transistor, 6-pin IC or 6-pin diode, and the semiconductor chip or IC packaged by ball grid array (BGA) technology is used, the invention is applicable even if the solder pads 1 for the aforementioned electrical component have different shapes, dimensions and specifications to form the solder resistant structures at the area of the circuit board between the solder pads 1. Accordingly, the solder resistant structures is adapted to form adjacent to a group of the solder pads 1 to prevent flashing and in a manner to dearly label the position to be tested, so as to prevent drawbacks associated with the conventional method. The method of the invention is applicable to the electrical component of any shape, size, color and direction. Therefore, the solder resistant structure is provided to solve flashing problem and allow the connection between each electrical component and the circuit board to be checked even after the reflow soldering process.

Summarizing from the above, the invention provides a method of preventing solder flashing between solder pads on the circuit board, and connection for each of the electrical components to the circuit board is checked even after the reflow-soldering process. This fulfills both requirements for manufacture and other related tests. Meanwhile, no modification of the electrical component or addition of other devices is required in the invention to simplify the manufacturing steps and increase cost effectiveness. Thus, the production efficiency and product reliability are significantly improved as to increase the product yield.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. A method of preventing solder flash between solder pads on a circuit board, allowing an electrical component to be soldered via a solder material to the solder pads of the circuit board, the method comprising the step of: forming a solder resistant structure on an area between at least two adjacent solder pads on the circuit board such that the solder resistant structure isolates flash of the solder material applied on one of the at least two adjacent solder pads from flash of the solder material applied on the other one of the at least two adjacent solder pads so as to prevent solder flash between the at least two adjacent solder pads.

2. The method of claim 1, wherein the solder resistant structure is greater than or equal to the solder pads in height.

3. The method of claim 1, wherein the solder resistant structure is formed with at least one isolating portion.

4. The method of claim 1, wherein the solder resistant structure is formed with at least one buffering portion.

5. A method of preventing solder flash between solder pads on a circuit board, allowing an electrical component to be soldered via a solder material to the solder pads of the circuit board, the electrical component being selected from the group consisting of a resistor, capacitor, inductor, tantalum (Ta) capacitor, electrolyzed capacitor and rounded electrolyzed capacitor, the method comprising the step of: forming a solder resistant structure on an area between at least two adjacent solder pads on the circuit board such that the solder resistant structure isolates flash of the solder material applied on one of the at least two adjacent solder pads from flash of the solder material applied on the other one of the at least two adjacent solder pads so as to prevent solder flash between the at least two adjacent solder pads.

6. The method of claim 5, wherein the solder resistant structure is greater than or equal to the solder pads in height.

7. The method of claim 5, wherein the solder resistant structure is formed with at least one isolating portion.

8. The method of claim 5, wherein the solder resistant structure is formed with at least one buffering portion.

9. A method of preventing solder flash between solder pads on a circuit board, allowing an electrical component to be soldered via a solder material to the solder pads of the circuit board, the electrical component being selected from a transistor or 3-pin diode, the method comprising the step of: forming a solder resistant structure on an area between at least two adjacent solder pads on the circuit board such that the solder resistant structure isolates flash of the solder material applied on one of the at least two adjacent solder pads from flash of the solder material applied on the other one of the at least two adjacent solder pads so as to prevent solder flash between the at least two adjacent solder pads.

10. The method of claim 9, wherein the solder resistant structure is greater than or equal to the solder pads in height.

11. The method of claim 9, wherein the solder resistant structure is formed with at least one isolating portion.

12. The method of claim 9, wherein the solder resistant structure is formed with at least one buffering portion.

13. A method of preventing solder flash between solder pads on a circuit board, allowing an electrical component to be soldered via a solder material to the solder pads of the circuit board, the electrical component being selected from the group consisting of a row resistor, row capacitor, integrated circuit (IC), connector and resonance transistor, the method comprising the step of: forming a solder resistant structure on an area between at least two adjacent solder pads on the circuit board such that the solder resistant structure isolates flash of the solder material applied on one of the at least two adjacent solder pads from flash of the solder material applied on the other one of the at least two adjacent solder pads so as to prevent solder flash between the at least two adjacent solder pads.

14. The method of claim 13, wherein the solder resistant structure is greater than or equal to the solder pads in height.

15. The method of claim 13, wherein the solder resistant structure is formed with at least one isolating portion.

16. The method of claim 13, wherein the solder resistant structure is formed with at least one buffering portion.

17. A method of preventing solder flash between solder pads on a circuit board, allowing an electrical component to be soldered via a solder material to the solder pads of the circuit board, the electrical component being selected from the group consisting of a 6-pin transistor, 6-pin integrated circuit (IC) and 6-pin diode, the method comprising the step of: forming a solder resistant structure on an area between at least two adjacent solder pads on the circuit board such that the solder resistant structure isolates flash of the solder material applied on one of the at least two adjacent solder pads from flash of the solder material applied on the other one of the at least two adjacent solder pads so as to prevent solder flash between the at least two adjacent solder pads.

18. The method of claim 17, wherein the solder resistant structure is greater than or equal to the solder pads in height.

19. The method of claim 17, wherein the solder resistant structure is formed with at least one isolating portion.

20. The method of claim 17, wherein the solder resistant structure is formed with at least one buffering portion.

21. A method of preventing solder flash between solder pads on a circuit board, allowing electrical component to be soldered via a solder material to the solder pads of the circuit board, the electrical component being selected from a BGA packaged semiconductor chip or an integrated circuit (IC), the method comprising the step of: forming a solder resistant structure on an area between at least two adjacent solder pads on the circuit board such that the solder resistant structure isolates flash of the solder material applied on one of the at least two adjacent solder pads from flash of the solder material applied on the other one of the at least two adjacent solder pads so as to prevent solder flash between the at least two adjacent solder pads.

22. The method of claim 21, wherein the solder resistant structure is greater than or equal to the solder pads in height.

23. The method of claim 21, wherein the solder resistant structure is formed with at least one isolating portion.

24. The method of claim 21, wherein the solder resistant structure is formed with at least one buffering portion.
